(19) United States
(12) Patent Application Publication
(10) Pub. No.: US 2003/0050579 A1
(43) Pub. Date: Mar. 13, 2003

(54) Bi-directional oscillation leg massager

(76) Inventors: Paul Hsieh, Arcadia, CA (US); Lawrence Lin, Shen Lin S. RD (TW)

Correspondence Address: DAVID L. DAVIS, ESQ., 203 MAIN STREET, METUCHEN, NJ, 08840, US

(21) Appl. No.: 09/950,137

(22) Filed: Sep. 10, 2001

(51) Int. Cl. A61H 7/00

(52) U.S. Cl. 601/104; 601/29

(57) ABSTRACT

A bi-directional oscillation leg massager including a housing, a power drive mounted in the housing and adapted to output a rotary driving force, and a combination oscillation mechanism. The combination oscillation mechanism includes a drive member for synchronous rotation with the power drive, a first driven member adapted to reciprocate in a first linear path upon rotation of the drive member, a second driven member adapted to reciprocate in a second linear path not parallel to the first linear path upon reciprocation of the first driven member, and a guide member coupled between the first driven member and the second driven member and adapted to guide reciprocating motion of the second driven member in the second linear path. A support block is fastened to the second driven member and is adapted to support the users legs.

### BACKGROUND OF THE INVENTION

The present invention relates to massaging apparatus and, more specifically, to a bi-directional oscillation leg massager that oscillates the user's legs in transverse direction as well as longitudinal direction when operated.

Regular commercially available oscillation leg massagers commonly use a power drive to reciprocate an oscillation mechanism, so as oscillate the user's legs in transverse direction. Because these oscillation leg massagers only oscillate the user's legs in transverse direction, the massaging effect is insignificant. It would therefore be desirable to provide a powered leg massager which oscillates the user's legs both longitudinally and transversely so as to be more effective.

### SUMMARY OF THE INVENTION

According to the present invention, there is provided a bi-directional oscillation leg massager, which oscillates the user's legs in transverse direction as well as longitudinal direction to achieve high massaging effect when operated. To accomplish this, the inventive bi-directional oscillation leg massager comprises a housing, a power drive mounted in the housing and adapted to output a rotary driving force, and a combination oscillation mechanism. The combination oscillation mechanism has a drive member for synchronous rotation with the power drive, a first driven member adapted to reciprocate in a first linear path upon rotation of the drive member, a second driven member adapted to reciprocate in a second linear path not parallel to the first linear path upon reciprocation of the first driven member, and a guide member coupled between the first driven member and the second driven member and adapted to guide reciprocating motion of the second driven member in the second linear path. A support block is fastened to the second driven member and is adapted to support the user's legs.

### BRIEF DESCRIPTION OF THE DRAWINGS

The foregoing will be more readily apparent upon reading the following description in conjunction with the drawings in which like elements in different figures thereof are identified by the same reference numeral and wherein:

FIG. 1 is a perspective view of an illustrative embodiment of a bi-directional oscillation leg massager constructed according to the present invention;

FIG. 2 is an exploded view of the bi-directional oscillation leg massager shown in FIG. 1;

FIG. 3 is a side view in section of the bi-directional oscillation leg massager shown in FIG. 1, showing the drive member in a first angular orientation;

FIG. 4 is view similar to FIG. 3 showing the drive member in a second angular orientation offset 90° from the first angular orientation;

FIG. 5 is a top view, partially cut away, of the bi-directional oscillation leg massager shown in FIG. 1 corresponding to the drive member being in the first angular orientation; and

FIG. 6 is a view similar to FIG. 5 corresponding to the drive member being in the second angular orientation.

### DETAILED DESCRIPTION OF THE PREFERRED EMBODIMENT

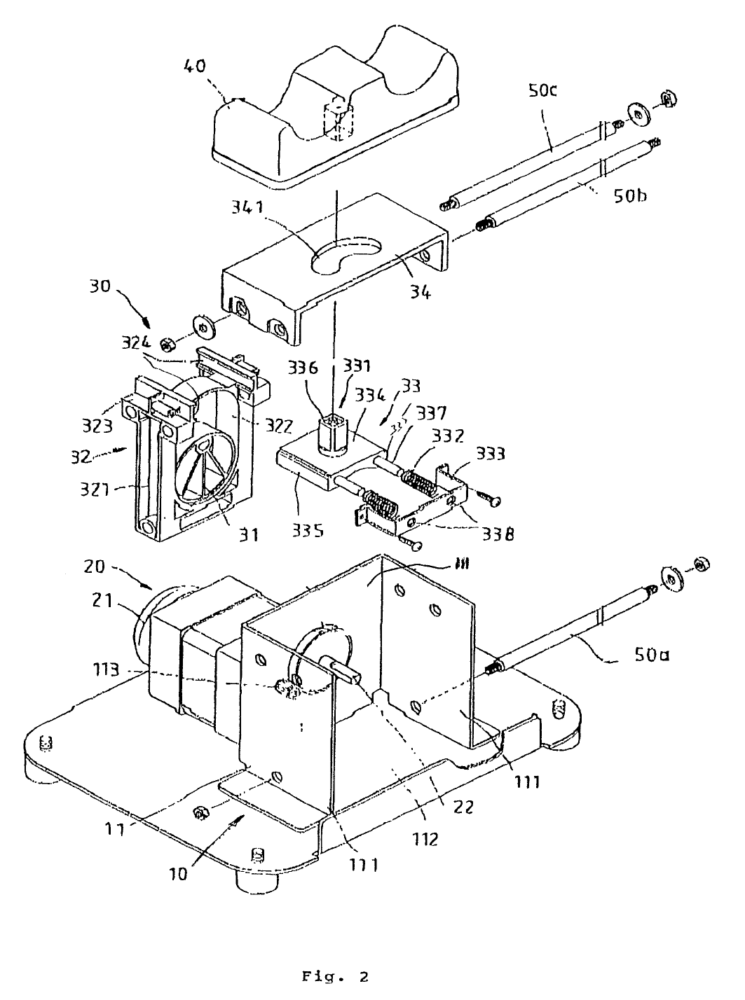

Referring to the drawings, the inventive bi-directional oscillation leg massager comprises a housing 10, a power drive 20, a combination oscillation mechanism 30, and a support block 40, as best seen in FIG. 2.

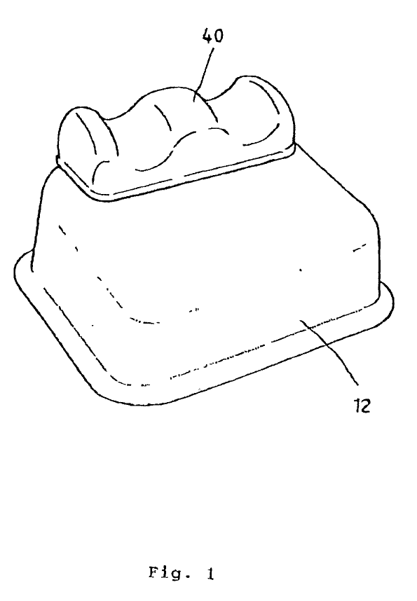

The housing 10 is comprised of an inner casing 11 and an outer casing 12 (FIG. 1). The inner casing 11 comprises three peripheral sidewalls 111 defining an open chamber 112. A receiving hole 113 in one peripheral sidewall 111 is in communication between the open chamber 112 and the space outside the inner casing 11. The outer casing 12 covers the inner casing 11, making the housing 10 attractive, as best seen in FIG. 1.

The power drive 20 is adapted to output a rotary driving force subject to a predetermined revolving speed, and comprises a motor 21, a transmission gear set (not shown), and a power output shaft 22. The transmission gear set is coupled between the motor 21 and the power output shaft 22. When starting the motor 21, the power output shaft 22 is rotated at a predetermined revolving speed. The motor 21 is fixedly mounted in the receiving hole 113, keeping the power output shaft 22 suspended in the open chamber 112.

The combination oscillation mechanism 30 comprises a drive member 31, a first driven member 32, a second driven member 33, and a guide member 34. The drive member 31 is shaped like a circular disk and is eccentrically fixedly fastened to the power output shaft 22 for synchronous rotation therewith. The first driven member 32 comprises an open frame 321, which defines an oval motion space 322 at the center, and a track 323 provided at the top of the open frame 321. The minor axis of the oval motion space 322 is not greater than the outer diameter of the drive member 31 so that the drive member 31 can be put in the motion space 322 and rotated to reciprocate the first drive member 32 in a first linear path, i.e., the radial direction across the axis of the power output shaft 22. The track 323 defines two parallel sliding grooves 324.

The second driven member 33 comprises a sliding block 331, two spring elements 332, and a stopper 333. The sliding block 331 comprises a body 334, two side rails 335, a top shaft 336, and two stop rods 337. The side rails 335 are formed integral with two opposite lateral sides of the body 334 and are respectively inserted into the sliding grooves 324 in the track 323 of the first driven member 32, for enabling the sliding block 331 to be reciprocated in a second linear path, i.e., in axial direction along the axis of the power output shaft 22 of the power drive 20. The upright shaft 336 is provided at the top sidewall of the body 334. The stop rods 337 are provided at the rear side of the body 334 adjacent to the side rails 335. The spring elements 332 are compression springs respectively mounted on the stop rods 337. The stopper 333 is fixedly fastened to the open frame 321 of the first driven member 32 and stopped at the compression springs 332 against the body 324, having two through holes 338 corresponding to the stop rods 337.

Axles 50b and 50c are inserted through the guide member 34 to secure the guide member 34 to the inner casing 11 of the housing 10. The axles 50a, 50b and 50c are also inserted through the open frame 321 of the combination oscillation mechanism 30, enabling the open frame 321 to be reciprocated along the axles 50b and 50c. The guide member 34 has a smoothly arched guide slot 341, which receives the upright shaft 336 of the combination oscillation mechanism 30.

The support block 40 is coupled to the upright shaft 336 of the combination oscillation mechanism 30, having a side-by-side concave contour adapted to conformally support the users legs.

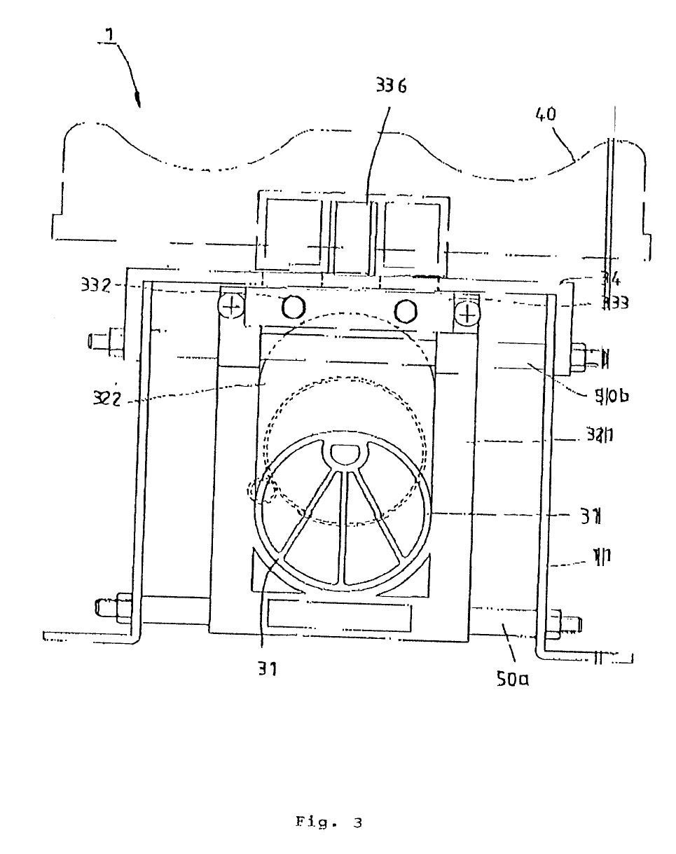

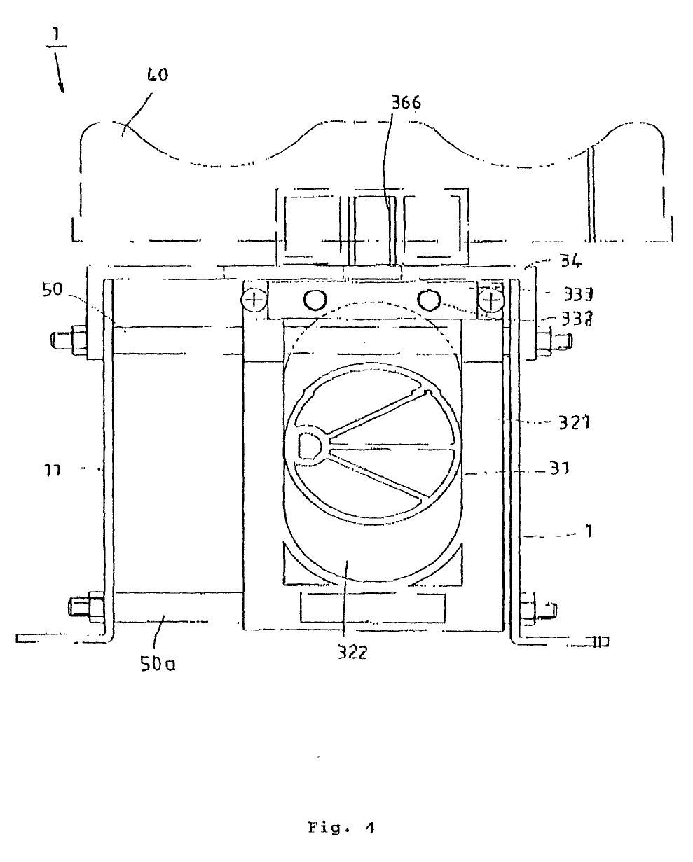

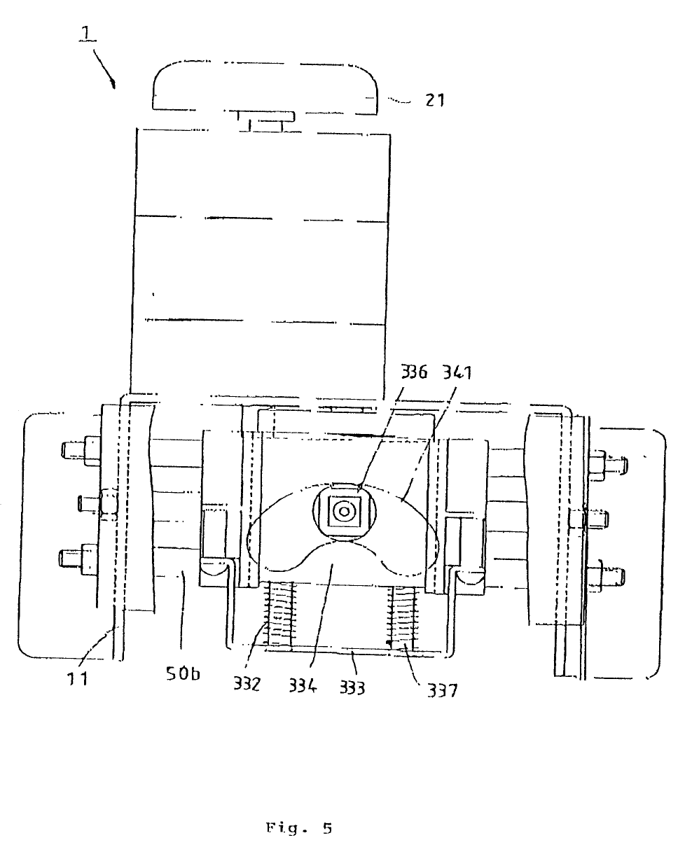

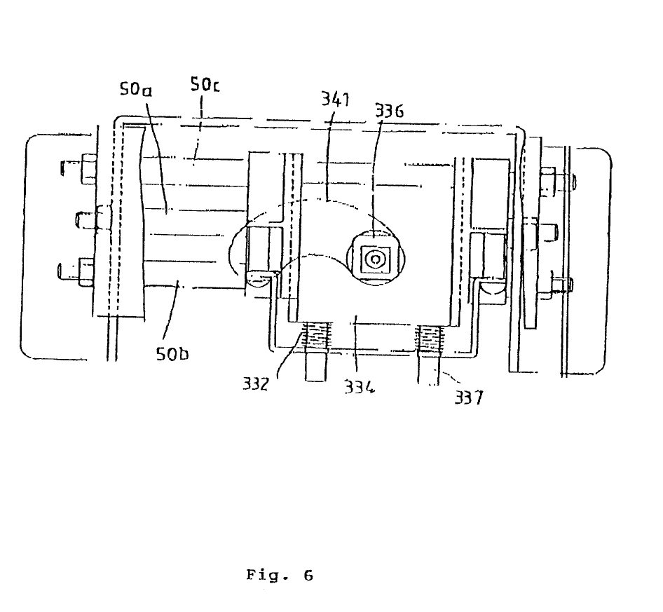

The function and advantages of the inventive leg massager are outlined hereinafter. When starting the motor 21 of the power drive 20 to rotate the power output shaft 22 through the transmission gear set, the drive member 31 is rotated eccentrically to reciprocate the first driven member 32 and the second driven member 33 in the first linear path in direction across the axis of the power output shaft 22 (see FIGS. 3 and 4). Because the upright shaft 336 of the second driven member 33 is coupled to the guide slot 341 of the guide member 34, the second driven member 33 is reciprocated in the second linear path when moved with the first driven member 32 (see FIGS. 5 and 6). Further, when reciprocating the second driven member 33 in the second linear path, the body 334 of the second driven member 33 is continuously alternatively forced to compress and release the compression springs 332 to facilitate reciprocating motion of the second driven member 33. Therefore, the support block 40 is continuously reciprocated with the upright shaft 336 in the first linear path and the second linear path to oscillate the users legs in both transverse and longitudinal directions.

As indicated above, the bi-directional leg massager provides transverse and longitudinal reciprocating motions at the same time to effectively massage the muscles of the users legs.

While an illustrative embodiment of the present invention has been shown and described, it will be understood that various modifications and changes could be made thereunto without departing from the spirit and scope of the invention, as defined by the appended claims.

What is claimed is:

1. A bi-directional oscillation leg massager comprising:
a housing;
a power drive mounted in said housing and adapted to output a rotary driving force at a predetermined revolving speed;
a combination oscillation mechanism including:
a drive member coupled to a power output end of said power drive for rotation upon operation of said power drive;
a first driven member coupled to said drive member and adapted to reciprocate in a first linear path upon rotation of said drive member;
a second driven member coupled to said first driven member and adapted to reciprocate in a second linear path not parallel to said first linear path upon reciprocation of said first driven member; and
a guide member coupled between said first driven member and said second driven member and adapted to guide reciprocating motion of said second driven member in said second linear path; and
a support block fastened to said second driven member and adapted to support the users legs.

2. The bi-directional oscillation leg massager according to claim 1 wherein said drive member is shaped like a circular disk and is eccentrically fixedly fastened to a power output shaft of said power drive for synchronous rotation with said power output shaft.

3. The bi-directional oscillation leg massager according to claim 1 wherein said first driven member defines an oval motion space having a minor axis not smaller than the outer diameter of said drive member, and said drive member is mounted in said oval motion space and is rotated to reciprocate said first driven member in said first linear path.

4. The bi-directional oscillation leg massager according to claim 1 wherein said first driven member comprises two parallel sliding grooves, and said second driven member comprises two rails each coupled to a respective one of said two sliding grooves for enabling said second driven member to be reciprocated in said second linear path.

5. The bi-directional oscillation leg massager according to claim 4 wherein said second driven member comprises a sliding block, two springs, and a stopper fixedly fastened to the open frame of said first driven member, said sliding block comprising a body, an upright top shaft, and two stop rods, said body having two opposite lateral sides respectively integral with said rails, said upright top shaft being fixedly provided at a top sidewall of said body, said stop rods being backwardly extended from a rear side of said body adjacent to said rails, and the springs of said second driven member each being respectively mounted on a respective one of the two stop rods of said sliding block and located between said body and said stopper.

6. The bi-directional oscillation leg massager according to claim 5 wherein said guide member comprises a smoothly arched guide slot through which the upright top shaft of said sliding block is inserted and connected to said support block.
